(19) United States
(12) Patent Application Publication
(10) Pub. No.: US 2003/0060552 A1
(43) Pub. Date: Mar. 27, 2003

(54) Corona resistant thermoplastic blends and methods for manufacture thereof

(76) Inventors: Kim G. Balfour, Delanson, NY (US); Michael A. Brown, Middleburtghm, NY (US); Georgia Dris Fishburn, Slingerland, NY (US); Nancy Ellen Frost, Ballston Lake, NY (US); John Raymond Krahn, Schenectady, NY (US); Christian Lietzau, Rhinebeck, NY (US)

Correspondence Address: CANTOR COLBURN, LLP, 55 GRIFFIN ROAD SOUTH, BLOOMFIELD, CT, 06002

(21) Appl. No.: 10/063,697

(22) Filed: May 8, 2002

Related U.S. Application Data
(60) Provisional application No. 60/289,375, filed on May 8, 2001.

(51) Int. Cl. C08L 1/00; C08J 3/00; C08K 3/30; C08K 3/26; C08K 3/18; C08K 3/22; C08K 3/34

(52) U.S. Cl. 524/423; 524/425; 524/430

(57) ABSTRACT

A corona resistant thermoplastic composition comprises about 15 to about 85 wt % of a thermoplastic resin comprising polyarylene ether and polyarylene sulfide; about 10 to about 30 wt % glass fibers; and about 5 to about 51 wt % of a mineral filler having an average radius of gyration effective to produce a corona resistance of greater than 200 hours when continuously subjected to a voltage of 5000 volts and wherein the weight percents are based on total composition. The compositions find particular utility in automotive applications, for example in under-the-hood applications such as ignition coil cases, as copier components, circuit breaker components, electrical switches, insulators, electronic encapsulants, and other applications requiring enhanced corona resistance.

### CROSS REFERENCE TO RELATED APPLICATIONS

This application is related to and claims priority from Provisional Application No. 60/289,375 filed on May 8, 2001, the entire contents of which are incorporated by reference herein.

### BACKGROUND OF INVENTION

The present disclosure relates to thermoplastic compositions and methods for their manufacture.

Thermoplastic compositions are generally used as insulating materials for electrical conductors. However, upon exposure to a corona discharge, many of these thermoplastic compositions fail. Failure is often observed in high voltage applications such as electrical motor applications, ignition coils, distributor caps, and the like. Loss of insulating ability, which typically occurs after failure, renders the thermoplastic composition unreliable for these types of applications.

A number of patents disclose improvements in the corona resistance of thermoplastic compositions. For example, U.S. Pat. No. 3,577,346 to McKeown discloses adding organometallic compounds based on silicon, germanium, tin, lead, arsenic, antimony, bismuth, iron, ruthenium or nickel to a thermoplastic resin for increasing corona resistance. Corona resistance of up to four hundred times greater than those of thermoplastic resins without the organo-metallic additives is reported. DiGuilio et al, in U.S. Pat. No. 3,228,883, discloses a thermoplastic composition, wherein the corona resistance is increased by the addition of non-hygroscopic mineral fillers such as zinc, iron, aluminum or silicon oxide. U.S. Pat. No. 4,760,296 to Johnston et al. discloses corona resistant thermoplastic compositions wherein the corona resistance is achieved by using inorganic fillers derived from organo-aluminates or organo-silicates such as fine alumina, and silica having a critical particle size. U.S. Pat. No. 5,720,264 to Oosuka et al. discloses a corona resistant housing for ignition coils for an internal combustion engine. The housing is molded of a material containing one or more of polyphenylene sulfide, polyphenylene oxide, polyarylate, polyether imide, or a liquid crystal polymer, together with glass fiber reinforcing filler. Similarly U.S. Pat. No. 5,476,695 discloses a resinous composition for a sparking plug cap containing an alloy of polyphenylene sulfide with polyphenylene oxide, polyarylate, polyether imide, or a liquid crystalline polymer. The resinous composition also incorporates inorganic filler. While suitable for their intended purposes, there nonetheless remains a need for thermoplastic compositions having improved corona resistance that are easily molded for a variety of applications.

### SUMMARY OF INVENTION

A corona resistant thermoplastic composition comprises about 15 to about 85 wt % of a thermoplastic resin comprising polyarylene ether and polyarylene sulfide; about 10 to about 30 wt % glass fibers; and about 5 to about 51 wt % of a mineral filler having an average radius of gyration effective to produce a corona resistance of greater than 200 hours when continuously subjected to a voltage of 5000 volts and wherein the weight percents are based on the total weight of the composition. The compositions find particular utility in automotive applications, for example in under-the-hood applications such as ignition coil cases, as copier components, circuit breaker components, electrical switches, insulators, electronic encapsulants, and other applications requiring enhanced corona resistance.

The above described and other features are exemplified by the following detailed description.

### DETAILED DESCRIPTION

It has been unexpectedly discovered that a thermoplastic composition comprising a polyarylene ether, a polyarylene sulfide, glass fibers and mineral fillers provide corona resistance for articles. The corona resistant compositions are suitable for use in electronic devices such as, for example in photocopier components and laser printers, automobile spark plugs, ignition coil cases, circuit breaker components, insulation and the like. Advantageously, the compositions can be molded into various shapes and forms such as fibers, pipes, rods, films, sheets and bearings, renders them useful as sealants and molding materials for laminates and joints.

Suitable thermoplastic resins include blends of polyarylene ethers with polyarylene sulfides. The term polyarylene ether includes polyphenylene ether (PPE), polyarylene ether ionomers, polyarylene ether copolymers, polyarylene ether graft copolymers, block copolymers of polyarylene ethers with alkenyl aromatic compounds or vinyl aromatic compounds, and the like; and combinations comprising at least one of the foregoing polyarylene ethers. Partially crosslinked polyarylene ethers, as well as mixtures of branched and linear polyarylene ethers may also be used in the corona resistant compositions. The polyarylene ethers preferably comprise a plurality of structural units of the formula (I):

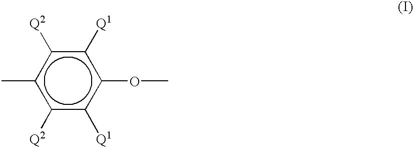

wherein for each structural unit, each Q¹ and Q² are independently a halogen, a primary or secondary lower alkyl (e.g., an alkyl containing up to 7 carbon atoms), a phenyl, a haloalkyl, an aminoalkyl, a hydrocarbonoxy, a halohydrocarbonoxy wherein at least two carbon atoms separate the halogen and oxygen atoms, or the like. More preferably, each Q¹ is an alkyl or a phenyl, and even more preferably an alkyl group having from 1 to 4 carbon atoms and each Q² is hydrogen.

The polyarylene ethers may be either homopolymers or copolymers. The preferred homopolymers are those containing 2,6-dimethylphenylene ether units. Suitable copolymers include random copolymers containing, for example, such units in combination with 2,3,6-trimethyl-1,4-phenylene ether units or alternatively, copolymers derived from copolymerization of 2,6-dimethylphenol with 2,3,6-trimethylphenol. Also included are polyarylene ethers containing moieties prepared by grafting vinyl monomers or polymers such as polystyrenes, as well as coupled polyarylene ethers in which coupling agents such as low molecular weight polycarbonates, quinones, heterocycles, and formals undergo reaction with the hydroxy groups of two polyarylene ether chains to produce a higher molecular weight polymer. Suitable polyarylene ethers further include combinations comprising at least one of the above homopolymers or copolymers.

The polyarylene ethers preferably have a number average molecular weight of about 3,000 to about 40,000 atomic mass units (amu) and a weight average molecular weight of about 20,000 to about 80,000 amu, as determined by gel permeation chromatography. The polyarylene ethers preferably have an intrinsic viscosity of about 0.10 to about 0.60 deciliters per gram (dl/g), and preferably about 0.29 to about 0.48 dl/g, as measured in chloroform at 25° C. It is also possible to utilize a blend of high intrinsic viscosity polyarylene ether and low intrinsic viscosity polyarylene ether so long as the intrinsic viscosity of the blend lies between about 0.1 to about 0.6 dl/g. Determining an exact ratio when two intrinsic viscosities are used will depend somewhat on the exact intrinsic viscosities of the polyarylene ether used and the ultimate physical properties that are desired.

The polyarylene ethers are generally prepared by the oxidative coupling of at least one monohydroxyaromatic compound such as 2,6-dimethylphenol or 2,3,6-trimethylphenol. Catalyst systems employed for such coupling; typically contain at least one heavy metal compound such as a copper, manganese, or cobalt compound, usually in combination with various other materials.

Particularly useful polyarylene ethers are those that comprise molecules having at least one aminoalkyl-containing end group. The aminoalkyl-containing end group is preferably located in an ortho position to the hydroxy group. Products containing such end groups may be obtained by incorporating an appropriate primary or secondary monoamine such as di-n-butylamine or dimethylamine as one of the constituents in the oxidative coupling reaction mixture. Also preferred are 4-hydroxybiphenyl end groups, generally obtained from reaction mixtures in which a by-product diphenoquinone is present, especially in a copper-halide-secondary or tertiary amine system. A substantial proportion of the polymer molecules, typically constituting as much as about 90 wt % (weight percent) of the polymer, may contain at least one of the aminoalkyl-containing and 4-hydroxybiphenyl end groups.

The term polyarylene sulfide includes polyphenylene sulfide (PPS), polyarylene sulfide ionomers, polyarylene sulfide copolymers, polyarylene sulfide graft copolymers, block copolymers of polyarylene sulfides with alkenyl aromatic compounds or with vinyl aromatic compounds, and combinations comprising at least one of the foregoing polyarylene sulfides. Partially crosslinked polyarylene sulfides, as well as mixtures of branched and linear polyarylene sulfides, may be used in the corona resistant compositions.

Polyarylene sulfides are known polymers comprising a plurality of structural units of the formula (II):

—R—S— (II)

wherein R is an aromatic radical such as phenylene, biphenylene, naphthylene, oxydiphenyl, diphenyl sulfone, or is a lower alkyl radical, or a lower alkoxy radical, or halogen substituted derivatives thereof. The lower alkyl and alkoxy substituents typically have about one to about six carbon atoms, for example methyl, ethyl, propyl, isobutyl, n-hexyl, and the like. Preferably, the polyarylene sulfide is a polyphenylene sulfide having repeating structural units of formula (III).

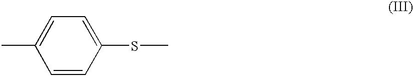

The polyarylene sulfide preferably has a melt index of about 10 grams to about 10,000 grams per 10 minutes when measured by ASTM D-1238-74 (315.6° C.; load, 5 kg). In another embodiment, the polyarylene sulfide will have an inherent viscosity within the range of about 0.05 to about 0.4, and more preferably about 0.1 to about 0.35, as determined at 206° C. in 1-chloronaphthalene at a polymer concentration of 0.4-g/100 mL solution.

Suitable polyarylene sulfides may be prepared according to U.S. Pat. No. 3,354,129, by reacting at least one polyhalo-substituted cyclic compound containing unsaturation between adjacent ring atoms such as 1,2-dichlorobenzene, 1,3-dichlorobenzene, 2,5-dibromobenzene and 2,5-dichlorotoluene with an alkali metal sulfide in a polar organic compound at an elevated temperature. The alkali metal sulfides are generally monosulfides of sodium, potassium, lithium, rubidium, and cesium. Generally the polar organic compound will substantially dissolve both the alkali metal sulfide and the polyhalo-substituted aromatic compound or other reaction by-products. The polymers can also be manufactured by the method described in British Pat. No. 962,941 wherein metal salts of halothiophenols are heated to a polymerization temperature.

Suitable alloys or blends of polyarylene ether and polyarylene sulfide comprise, based on the total amount of thermoplastic resin in the composition, an amount of greater than or equal to about 10, preferably greater than or equal to about 20, and more preferably greater than or equal to about 25 wt % of polyarylene sulfide. It is generally desirable to have the polyarylene sulfide present in an amount less than or equal to about 99, preferably less than or equal to about 80, most preferably less than or equal to about 70 wt % of the total amount of thermoplastic resin. The polyarylene ether is generally present in an amount of greater than or equal to about 1, preferably greater than or equal to about 5, more preferably greater than or equal to about 10, and most preferably greater than or equal to about 15 wt % of the total amount of thermoplastic resin in the composition. It is generally desirable to have the polyarylene ether present in an amount less than or equal to about 90, preferably less than or equal to about 50, more preferably less than or equal to about 35, and most preferably less than or equal to about 28 wt % of the total amount of thermoplastic resin.

The thermoplastic resin in the composition comprises an amount of greater than or equal about 15, preferably greater than or equal to about 20, more preferably greater than or equal to about 25, most preferably greater than or equal to about 35 wt % of the total composition. Also preferred is an amount less than or equal to about 85, preferably less than or equal to about 70, and more preferably less than or equal to about 65 wt % of the total composition.

Other thermoplastic resins that may also be added to the composition include polyacetal, polyacrylic, styrene acrylonitrile, acrylonitrile-butadiene-styrene (ABS), polycarbonate, polystyrene, polyethylene, polypropylene, polyethylene terephthalate, polybutylene terephthalate, nylons (nylon-6, nylon-6/6, nylon-6/10, nylon-6/12, nylon-11 or nylon-12), polyamideimide, polyarylate, polyurethane, ethylene propylene diene rubber (EPR), ethylene propylene diene monomer (EPDM), polyarylsulfone, polyethersulfone, polyphenylene sulfide, polyvinyl chloride, polysulfone, polyetherimide, polytetrafluoroethylene, fluorinated ethylene propylene, perfluoroalkoxyethylene, polychlorotrifluoroethylene, polyvinylidene fluoride, polyvinyl fluoride, polyetherketone, polyether etherketone, polyether ketone ketone, and combinations comprising at least one of the foregoing thermoplastics.

For example, suitable impact modifiers include block copolymers such as, for example, A-B-A triblock copolymers and A-B diblock copolymers. The A-B-A and A-B type block copolymer may be thermoplastic rubbers comprised of one or two alkenyl aromatic blocks, which are typically styrene blocks and a rubber block, e.g., a butadiene block, which may be partially hydrogenated. Mixtures of these diblock and triblock copolymers are especially useful. Suitable A-B and A-B-A type block copolymers are disclosed in, for example, U.S. Pat. Nos. 3,078,254, 3,402,159, 3,297,793, 3,265,765, and 3,594,452 and U.K. Patent 1,264,741. Non-limiting examples of typical species of A-B and A-B-A block copolymers include polystyrene-polybutadiene (SBR), polystyrene-poly(ethylene-propylene), polystyrene-polyisoprene, poly(α-methylstyrene)-polybutadiene, polystyrene-polybutadiene-polystyrene (SBR), polystyrene-poly(ethylene-propylene)-polystyrene, polystyrene-polyisoprene-polystyrene and poly(α-methylstyrene)-polybutadiene-poly(α-methylstyrene), as well as the selectively hydrogenated versions thereof, and the like. Mixtures of the aforementioned block copolymers are also useful. Such A-B and A-B-A block copolymers are available commercially from a number of sources, including Phillips Petroleum under the trademark Solprene, Shell Chemical Co., under the trademark Kraton, Dexco under the tradename Vector, and Kuraray under the trademark Septon. Impact modifiers, if present, are preferably used in amounts of about 1 to about 20 wt % based on the resin composition.

Thermosetting resins may also be added to the composition. Specific non-limiting examples of thermosetting resins include polyurethane, natural rubber, synthetic rubber, epoxy, phenolic, polyesters, polyamides, silicones, and combinations comprising at least one of the foregoing thermosetting resins. Where it is desirable to add additional thermoplastic or thermosetting resins or combinations of thermoplastic and thermosetting resins to the corona resistant composition, they may be added in an amount of about 1 to about 20 wt % based on the resin composition.

Glass fibers are preferably used in combination with mineral fillers to improve the corona resistance of the compositions. Glass fibers comprising about 50 to about 70 wt % SiO₂ (silica) are preferably used in the corona resistant composition. However greater or lesser amounts of SiO₂ may be used in the glass fiber compositions for unique applications. The glass fibers may also include Li₂O, Na₂O, K₂O, BeO, MgO, CaO, BaO, TiO₂, MnO, Fe₂O₃, NiO, CuO, AgO, ZnO, B₂O₃, Al₂O₃, F₂, WO₃, CeO₂, SnO₂, and combination comprising at least one of the foregoing substances. The selection of a particular glass composition is made in accordance with the desired processing characteristics and the final properties of the corona resistant composition desired for a particular use.

Useful glass fibers can generally be formed from a fiberizable glass including those fiberizable glasses referred to as “E-glass,” “A-glass,” “C-glass,” “D-glass,” “R-glass,” and “S-glass”. Glass fibers obtained from E-glass derivatives may also be used. Most reinforcement mats comprise glass fibers formed from E-glass and are included in the corona resistant compositions. Commercially produced glass fibers generally having nominal filament diameters of greater than or equal to about 8 micrometers are preferably used in the corona resistant compositions. Also preferred are filament diameters less than or equal to about 35, and more preferably less than or equal to about 15 micrometers. The filaments may be produced by steam or air blowing, flame blowing, and mechanical pulling processes. The preferred filaments for plastics reinforcement are made by mechanical pulling. Use of fibers having an asymmetrical cross section may also be used in the composition. The glass fibers may also be sized or unsized. Sized glass fibers are conventionally coated on at least a portion of their surfaces with a sizing composition selected for compatibility with the polymeric matrix material. The sizing composition facilitates wet-out and wet-through of the matrix material upon the fiber strands and assists in attaining desired physical properties in the composite.

In one embodiment, the glass fibers are glass strands that have been sized. In preparing the sized glass fibers, a number of filaments can be formed simultaneously, sized with a coating agent and then bundled into what is called a strand. Alternatively the strand itself may be first formed of filaments and then sized. The amount of sizing employed is generally an amount effective to bind the glass filaments into a continuous strand and is generally greater than or equal to about 0.1 wt % based on the total weight of the glass fibers in the strand. Also preferred, is an amount of less than or equal to about 5, and more preferably less than or equal to about 2 wt % based on the weight of the glass fibers. In another embodiment the amount of sizing is about 1.0 wt % based on the weight of the glass fibers.

In general, the glass fibers are present in the corona resistant composition in an amount of greater than or equal to about 10, preferably greater than or equal to about 12, and more preferably greater than or equal to about 15 wt % of the total composition. Also preferred is an amount less than or equal to about 30, more preferably less than or equal to about 28, and even more preferably less than or equal to about 25 wt % based on the total weight of the composition.

Suitable mineral fillers which may be used in the corona resistant compositions include, but are not limited to, asbestos, ground glass, kaolin and other clay minerals, silica, calcium silicate, calcium carbonate (whiting), magnesium oxide, zinc oxide, aluminum silicate, calcium sulfate, magnesium carbonate, sodium silicate, barium carbonate, bariumsulfate (barytes), metal fibers and powders, refractory fibers, titanium dioxide, mica, talc, chopped glass, alumina, alumina trihydrate, quartz, and wollastonite (calcium silicate). Talc, nanoclay (i.e., clay having a maximum linear dimension of about 30 micrometers), silica, and barium sulfate are most preferred.

The mineral fillers are preferably finely divided inorganic substances wherein the average radius of gyration is about less than or equal to about 50, preferably less than or equal to about 30, more preferably less than or equal to about 10, and most preferably less than or equal to about 5 micrometers. It is also desirable to have the average radius of gyration greater than or equal to about 0.0001, preferably greater than or equal to about 0.001, more preferably greater than or equal to about 0.01 and most preferably greater than or equal to about 0.1 micrometers. The mineral fillers may be in the form of plates having a maximum diameter preferably less than or equal to about 4000, and more preferably less than or equal to about 2000 micrometers. Alternatively, the mineral fillers may be in the form of needles i.e., whiskers, having an average maximum length preferably less than or equal to about 10,000, and more preferably less than or equal to about 4000 micrometers with an average maximum diameter preferably less than or equal to about 300 micrometers, and more preferably less than or equal to about 100 micrometers. The mineral filler may be present in an amount greater than or equal to about 5, preferably greater than or equal to about 10, more preferably greater than or equal to about 14 wt % of the total composition. Also preferred is an amount preferably less than or equal to about 51, more preferably less than or equal to about 40, and more preferably less than or equal to about 30 wt % of the total composition.

Other additives may also be present in the composition including, for example, antioxidants, lubricants, surfactants, antistatic agents, flow control agents, flow promoters, impact modifiers, nucleating agents, coupling agents, flame retardants, and the like. Similarly, addition of pigments and dyes (inorganic and organic) may also be used.

The compositions can be prepared by a number of procedures. In an exemplary process, the thermoplastic resin, glass fibers, and mineral fillers are fed into an extruder to produce molding pellets. In this manner, the glass and mineral fillers are dispersed in a polymeric matrix of the thermoplastic resin. In another procedure, glass and mineral fillers are mixed with the thermoplastic resin by dry blending, and then either fluxed on a mill and comminuted, or extruded and chopped. The composition can also be mixed and directly molded, e.g., by injection molding or other suitable transfer molding technique. Preferably, all of the components are free from water. In addition, compounding is preferably carried out so as to ensure that the residence time in the machine is short, the temperature is carefully controlled, the friction heat is utilized in part or in whole, and an intimate blend of components is obtained. In cases where frictional heating is utilized in part the remaining heat my be supplied through electrical heating bands mounted on the shearing device such as an extruder or through externally heated oil. A generally suitable machine temperature will be about 450 to about 800° F. Typical equipment for melt blending the various components of the corona resistant blends are two roll mills, twin screw extruders, Buss kneaders, and the like. The compounded composition can be extruded into granules or pellets, cut into sheets or shaped into briquettes for further downstream processing. The composition can then be molded in equipment generally employed for processing thermoplastic compositions, e.g., a Newbury type injection molding machine with cylinder temperatures of about 450 to about 750° F., and mold temperatures of about 150 to about 280° F.

The following non-limiting examples are presented for illustrative purposes only, and are not intended to limit the scope of the disclosure. All amounts are in weight percent unless otherwise stated.

### EXAMPLES

The components for each corona resistant composition shown in the examples below were extruded in a 30 mm twin screw extruder manufactured by Werner and Pfleiderer. The extruder had 9 barrels or heating zones set at temperatures of 250° C., 290° C., 290° C., 300° C., 310° C., 310° C., 310° C., 310° C. and 310° C. The die temperature was set at 290° C. The extruder was run at 300 rpm. The strand emanating from the extruder was pelletized, dried and subjected to injection molding to manufacture the test parts. Some of the properties of the various components used in the compositions are shown in Table 1. The amounts of each component employed in the various compositions are shown in Table 2. All of the compositions shown in Table 2, were prepared by using a masterbatch comprising 61 wt % polyphenylene sulfide, 23 wt % polyphenylene ether, 9 wt % flow promotor (Arkan P-125 obtained from Arakawa Chemical) and 7 wt % impact modifier (Kraton G 1651 obtained from Shell), with the exception of runs 7 and 8 where the masterbatch was not used. For runs 7 and 8, all ingredients were added directly in the extruder during extrusion. For all of the runs where the masterbatch was used, the glass fiber along with the filler was added to the extruder during the extrusion.

The test parts were exposed to accelerated corona aging, with high temperature (175° C.), high frequency (3 kHz) and high voltage (5 kV) utilizing a triangular waveform. The corona resistance is defined as the hours to dielectric breakdown through the bulk of the material due to the surface degradation from the applied corona. The “>” sign indicates that the material was still withstanding the applied voltage at that number of hours. In other words, the material had not exhibited dielectric breakdown and was still performing as an insulator. The corona resistance for each composition is shown in Table 2.

TABLE 1

| Component | Properties | Trade Name | Source |
|---|---|---|---|
| PPS | Viscosity = 450-650 centipoise | Fortron | Ticona |
| | at 310°, 1200 s⁻¹ | 0205 | |
| PPO | Intrinsic Viscosity = 0.46 | PPO | General |
| | | | Electric |
| | | | Co. |
| Talc | Average particle size = 3.0 | Cimpact | Luzrnac |
| | micrometers | Talc 610C | America |
| BaSO₄ | Average particle size = 5.5-7.0 | Cherokee | Zemex |
| | micrometers | Baryte 290 | |
| Silica | Average particle size = 22-25 | MinuSil 40 | Minco |
| | micrometers | | |
| Nanoclay | Average particle size = 16-22 | PGW | Nanocor |
| | micrometers | | |
| Glass Fiber | Filament diameter = 9.6-11 | 173X-11C | Owens |
| | micrometers | 4 MM | Corning |
| | Filament length = 4 mm | | |
| Flow | | Arkon P- | Arakawa |
| promoter | | 125 | Chemical |
| Impact | | Kraton | Shell |
| modifier | | G1651 | Chemical |
| Impact | | Septon 8006 | Kuraray |
| modifier | | | |

[t2]

TABLE 2

| | | | Flow | Impact | | | | | | Glass | | Total |
|---|---|---|---|---|---|---|---|---|---|---|---|---|
| | | | Promoter | modifier | | | | | PQW | Fiber | | Corona |
| | PPS | PPO | (P-125) | (KG1651) | Masterbatch | Talc | Silica | BaSO₄ | Nanoclay | (R73X GF) | | Resistant |
| No. | (wt %) | (wt %) | (wt %) | (wt %) | (wt %) | (wt %) | (wt %) | (wt %) | (wt %) | (wt %) | Total | Time (hrs) |
| 1 | 29.46 | 11.11 | 4.35 | 3.38 | 48.30 | 29.80 | | | | 21.90 | 100.00 | >2055 |
| 2 | 29.46 | 11.11 | 4.35 | 3.38 | 48.30 | 29.80 | | | | 21.90 | 100.00 | >1942 |
| 3 | 29.46 | 11.11 | 4.35 | 3.38 | 48.30 | 29.80 | | | | 21.90 | 100.00 | >1942 |
| 4 | 25.50 | 9.61 | 3.76 | 2.93 | 41.80 | | | 39.30 | | 18.90 | 100.00 | >1341 |
| 5 | 19.95 | 7.52 | 2.94 | 2.29 | 32.70 | | | 50.50 | | 16.80 | 100.00 | >1341 |
| 6 | 35.62 | 13.43 | 5.26 | 4.09 | 58.40 | 17.90 | | | | 23.70 | 100.00 | >1138 |
| 7 | 43.80 | 7.00 | 5.45 | 4.24 | | 14.90 | | | | 24.60 | 99.98 | >1138 |
| 8 | 30.00 | 20.00 | 5.50 | 5.00 | | 14.90 | | | | 24.60 | 100.00 | >1138 |
| 9 | 26.72 | 10.07 | 3.94 | 3.07 | 43.80 | 35.10 | | | | 21.10 | 100.00 | >1138 |
| 10 | 29.46 | 11.11 | 4.35 | 3.38 | 48.30 | 29.80 | | | | 21.90 | 100.00 | >1138 |
| 11 | 28.79 | 10.86 | 4.25 | 3.30 | 47.20 | | | 32.60 | | 20.20 | 100.00 | >566.5 |
| 12 | 32.39 | 12.21 | 4.78 | 3.72 | 53.10 | 24.10 | | | | 22.80 | 100.00 | >375 |
| 13 | 26.29 | 9.91 | 3.88 | 3.02 | 43.10 | | 34.80 | | | 22.10 | 100.00 | 395.5 |
| 14 | 26.29 | 9.91 | 3.88 | 3.02 | 43.10 | | 34.80 | | | 22.10 | 100.00 | 375.9 |
| 15 | 26.29 | 9.91 | 3.88 | 3.02 | 43.10 | | 34.80 | | | 22.10 | 100.00 | 310.7 |
| 16 | 32.51 | 12.26 | 4.80 | 3.73 | 53.30 | | | 25.00 | | 21.70 | 100.00 | 219.4 |
| 17 | 26.29 | 9.91 | 3.88 | 3.02 | 43.10 | | 34.80 | | | 22.10 | 100.00 | 217.7 |
| 18 | 26.29 | 9.91 | 3.88 | 3.02 | 43.10 | | 34.80 | | | 22.10 | 100.00 | 205.5 |
| 19 | 42.70 | 16.10 | 6.30 | 4.90 | 70.00 | | | | 10.00 | 20.00 | 100.00 | 151.1 |
| 20 | 42.70 | 16.10 | 6.30 | 4.90 | 70.00 | | | | 10.00 | 20.00 | 100.00 | 131.7 |
| 21 | 42.70 | 16.10 | 6.30 | 4.90 | 70.00 | | | | 10.00 | 20.00 | 100.00 | 119.5 |
| 22 | 34.10 | 12.86 | 5.03 | 3.91 | 55.90 | | 20.20 | | | 23.90 | 100.00 | 107 |
| 23 | 42.70 | 16.10 | 6.30 | 4.90 | 70.00 | | | | 10.00 | 20.00 | 100.00 | 103.8 |
| 24 | 42.70 | 16.10 | 6.30 | 4.90 | 70.00 | | | | 10.00 | 20.00 | 100.00 | 102.3 |
| 25 | 31.35 | 11.82 | 4.63 | 3.60 | 51.40 | | 25.30 | | | 23.30 | 100.00 | 89.6 |
| 26 | 36.91 | 13.92 | 5.45 | 4.24 | 60.50 | | 14.90 | | | 24.60 | 100.00 | 79.5 |
| 27 | 36.91 | 13.92 | 5.45 | 4.24 | 60.50 | | 14.90 | | | 24.60 | 100.00 | 73.2 |
| 28 | 45.75 | 17.25 | 6.75 | 5.25 | 75.00 | | | | 5.00 | 20.00 | 100.00 | 70.9 |

The corona resistant compositions and articles made from these compositions such as the above noted ignition coil cases, distributor caps, circuit breaker components, and the like, display corona resistance when subjected to a voltage of 5000 volts continuously for greater than or equal to about 200 hours, preferably greater than or equal to about 400 hours, more preferably greater than or equal to about 1000 hours and most preferably greater than or equal to about 1500 hours.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A corona resistant composition comprising:
about 15 to about 85 wt % of a thermoplastic resin comprising polyarylene ether and polyarylene sulfide;
about 10 to about 30 wt % glass fibers; and
about 5 to about 51 wt % of a mineral filler having an average radius of gyration effective to produce a corona resistance of greater than 200 hours when continuously subjected to a voltage of 5000 volts, wherein the weight percents are based on the weight of the total composition.

2. The composition of claim 1, wherein the thermoplastic composition has a corona resistance of greater than 400 hours when continuously subjected to a voltage of 5000 volts.

3. The composition of claim 1, wherein the thermoplastic composition has a corona resistance of greater than 1000 hours when continuously subjected to a voltage of 5000 volts.

4. The composition of claim 1, wherein the thermoplastic composition has a corona resistance of greater than 1500 hours when continuously subjected to a voltage of 5000 volts.

5. The composition of claim 1, wherein the thermoplastic composition comprises about 1 to about 90 wt % polyarylene ether and about 99 to about 10 wt % polyarylene sulfide based on the total amount of thermoplastic resin.

6. The composition of claim 1, further comprising about 1 wt % to about 20 wt % impact modifier and a flow promotor based on the total weight of the composition.

7. The composition of claim 1, wherein the glass fibers comprise E-glass, A-glass, C-glass, D-glass, R-glass, S-glass, or a combinations comprising at least one of the foregoing glasses.

8. The composition of claim 1, wherein the glass fibers comprise about 50 to about 70 wt % silica based on a total weight of the glass fiber.

9. The composition of claim 1, wherein the glass fibers have a filament diameter of about 8 micrometers to about 35 micrometers.

10. The composition of claim 1, wherein the glass fibers have a filament diameter of about 8 micrometers to about 15 micrometers.

11. The composition of claim 1, wherein the mineral filler is selected from the group consisting of asbestos, ground glass, kaolin, clay minerals, silica, calcium silicate, calcium carbonate, magnesium oxide, zinc oxide, aluminum silicate, calcium sulfate, magnesium carbonate, sodium silicate, barium carbonate, barium sulfate, titanium dioxide, mica, talc, chopped glass, alumina, alumina trihydrate, quartz, wollastonite, and combinations comprising at least one of the foregoing mineral fillers.

12. The composition of claim 1, wherein the mineral filler is a particulate material having an average radius of gyration of about 50 micrometers.

13. The composition of claim 1, wherein the mineral filler is a platelet having a maximum diameter of about 4,000 micrometers.

14. The composition of claim 1, wherein the mineral filler is a whisker having a maximum length of about 10,000 micrometers and an average diameter of less than about 300 micrometers.

15. A corona resistant thermoplastic resin composition comprising:
about 25 to about 70 wt % of a polyarylene sulfide resin based upon the total amount of thermoplastic resin;
about 15 to about 50 wt % of polyarylene ether resin based upon the total amount of thermoplastic resin;
about 10 to about 30 wt % of a glass fiber based upon the total weight of the composition, wherein the glass fiber has a filament diameter of about 8 micrometers to about 35 micrometers; and
about 5 to about 51 wt % of a mineral filler based upon the total weight of the composition, wherein the mineral filler is selected from the group consisting of talc, BaSO₄, silica and nanoclay, and wherein the mineral filler has an average radius of gyration effective to produce a corona resistance greater than 200 hours when continuously subjected to a voltage of 5000 volts.

16. The composition of claim 15, wherein the composition further comprises about 1 wt % to about 20 wt % of an impact modifier and a flow promotor based on the total weight of the composition.

17. The composition of claim 15, wherein the glass fiber is selected from the group consisting of an E-glass, an A-glass, a C-glass, an D-glass, an R-glass, an S-glass and combinations comprising at least one of the foregoing glass fibers.

18. The composition of claim 15, wherein the glass fiber comprises about 50 to about 70 wt % silica based upon a total weight of the glass fiber.

19. The composition of claim 15, wherein the glass fiber has a filament diameter of about 8 micrometers to about 15 micrometers.

20. The composition of claim 15, wherein the mineral filler is a particulate material having an average radius of gyration of about 50 micrometers.

21. The composition of claim 15, wherein the mineral filler is a platelet having a maximum diameter of about 4,000 micrometers.

22. The composition of claim 15, wherein the mineral filler is a whisker having a maximum length of about 10,000 micrometers and an average diameter of about 300 micrometers.

23. A method of making a corona resistant article comprising:
melt blending a composition comprising polyarylene oxide, polyarylene sulfide, about 10 to about 30 wt % glass fibers; and about 5 to about 51 wt % of a mineral filler having an average radius of gyration effective to produce a corona resistance greater than 1000 hours, wherein the weight percents are based on total composition to produce a blend; and
molding the blend into a hape.

24. An article comprising the composition of claim 1.

25. An article formed from the method of claim 23.
